(19) United States
(12) Patent Application Publication
(10) Pub. No.: US 2010/0017755 A1
(43) Pub. Date: Jan. 21, 2010

(54) SYSTEMS AND METHODS FOR GRAPHICALLY CONVEYING PATIENT MEDICAL INFORMATION

(76) Inventor: G. Lynn Rasmussen, Salt Lake City, UT (US)

Correspondence Address: David B. Tingey, 1800 Eagle Gate Tower, 60 East South Temple, Salt Lake City, UT, 84145, US

(21) Appl. No.: 12/503,071

(22) Filed: Jul. 14, 2009

Related U.S. Application Data
(60) Provisional application No. 61/080,992, filed on Jul. 15, 2008.

(51) Int. Cl. G06F 3/048

(52) U.S. Cl. 715/845; 715/854; 715/764

(57) ABSTRACT

Systems and methods for providing graphical information regarding one or more patients' medical information are described. The graphical information can be used in various methods of graphical comparison, including graphical diagnoses, graphical comparison between patients, over time with a single patient, and/or over time with and/or between multiple patients. The graphical information can be used in place of and/or in conjunction with existing methods and systems for conveying medical information, including one or more textual methods and systems. The graphical information is provided electronically to any electronic or computer device or is provided in hard copy, such as a part of a patient's chart. The use of graphical patient medical information permits rapid and improved conveyance of information, and improves recognition and understanding of the most relevant medical information.

### RELATED APPLICATIONS

The present invention claims priority to U.S. Provisional Patent Application No. 61/080,992 entitled SYSTEMS AND METHODS FOR GRAPHICALLY CONVEYING PATIENT MEDICAL INFORMATION, filed Jul. 15, 2008 and incorporated herein in its entirety.

### BACKGROUND OF THE INVENTION

1. Field of the Invention

The present invention relates to patient evaluation systems and methods, and more particularly to graphical methods and systems for rapidly conveying medical information.

2. Background and Related Art

Currently-available systems and methods for recording patient medical data and conveying the recorded data to others are cumbersome and inefficient. Additionally, currently-available systems and methods do a poor job of highlighting the most relevant or important information when the information is conveyed, increasing the risk of missing critical information that could be used to diagnose, treat, or otherwise assist a patient or doctor. The use of such systems and methods is time-consuming, causes unneeded delays, and may result in an unprofessional impression of medical professionals on patients.

For example, typical mechanisms and methods for conveying patient medical information involve words and descriptions provided in a somewhat-organized manner, requiring the medical professional to read through and evaluate a great deal of data. A amount of data needed to be perused may be essentially irrelevant to the medical professional's needs.

FIG. 1 illustrates the difficulties that may be encountered in perusing this type of information. FIG. 1 represents a list illustrating the informational content of a complete systems review. As FIG. 1 shows only the types of information that can be obtained during a complete systems review, it will be appreciated that a listing of information can become even more voluminous than the listing of information shown in FIG. 1. Therefore, it will be appreciated that physicians, nurses, administrators, and other medical professionals, as well as patients and other laypersons can find difficulty in reviewing, digesting, understanding, the information presented in conventional fashion, and especially in discerning the most important information contained in write-ups using conventional methods and systems.

Thus, while techniques currently exist that are used to for recording patient medical data and conveying the recorded data to others, challenges still exist, including that current techniques are cumbersome and inefficient. Accordingly, it would be an improvement in the art to augment or even replace current techniques with other techniques.

### SUMMARY OF THE INVENTION

The present invention relates to patient evaluation systems and methods, and more particularly to graphical methods and systems for rapidly conveying medical information.

Implementations of the present invention provide graphical information regarding one or more patients' medical information, and may be used in various methods of graphical comparison, including graphical comparison between patients, over time with a single patient, and/or over time with and/or between multiple patients. Implementations of the present invention may be used in place of and/or in conjunction with existing methods and systems for conveying medical information, including one or more textual methods and systems. The graphical information may be provided electronically to any electronic or computer device or may be provided in hard copy, such as a part of a patient's chart. The use of graphical patient medical information permits rapid and improved conveyance of information, and may improve recognition and understanding of the most relevant medical information, as will be understood below.

Implementations of the present invention utilize graphical methods and systems to rapidly convey medical information, such as to medical professionals and to laypersons, including to patients. While particular graphical methods and systems are described herein, the illustrated systems and methods are intended to be illustrative. It is anticipated that alternative graphical methods and systems may be utilized other than those specifically described herein, and such alternative implementations are embraced by the present invention and the full scope of the present invention should be determined by reference to the appended claims.

Implementations of the present invention utilize a graphical rating or scoring system in relation to multiple aspects of a patient's medical information, and may extend the analysis to all aspects of a patient's medical information. Each item of medical information may receive a rating, score, grade, mark, evaluation, or other count, such as from one to ten, one to five, one to fifty, zero to ten, etc., and the rating information may be stored. The received rating information may be received numerically or graphically, or may be determined based on one or more responses to queries as to the patient's medical information. The information may also be received electronically, such as utilizing a computer or electronic device, or may be transferred into an electronic format from a paper, dictation, or other format. The received rating information may then be displayed graphically, such as using a bar chart, a pie chart, utilizing color information, or by some other graphical format, where it can be quickly and rapidly communicated.

In at least some implementations, multiple individual pieces of information may be displayed graphically, and some individual pieces of information may be combined to provide one or more average scores, ratings, etc. The average of multiple scores, ratings, etc. may also be provided or displayed graphically, either as part of a graphical representation of the individual scores, ratings, etc., or individually, or in combination with multiple average scores, ratings, etc. representing averages of other information items. In some implementations, averages of several averages may be displayed, and any number of layers of averages may be provided. In some such implementations, a user may elect to drill down (and back up, if desired) through layers of graphical representations of averages, to better understand certain average scores and their components.

The graphical information provides a way to view, communicate, understand, and/or utilize medical information that has heretofore been unavailable. By way of example, medical professionals and even laypersons are able to quickly view and grasp a patient's medical situation using implementations of the present invention in ways that were previously impossible. The information may be additionally utilized in ways previously unavailable to assist in diagnosis and treatment.

While the methods and processes of the present invention have proven to be particularly useful in the area of medical care, those skilled in the art can appreciate that the methods and processes can be used in a variety of different applications, including in the area of providing dietary decisions, fitness evaluation, and other types of care, diagnosis and treatments to an individual.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the present invention may be learned by the practice of the present invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a PRIOR ART textual method for conveying patient medical information;

FIG. 2 shows a representative computer system that may be used in conjunction with embodiments of the present invention;

FIG. 3 shows a representative networked computer environment that may be used in conjunction with embodiments of the present invention;

FIGS. 4-13 illustrate representative graphical displays that are illustrative of features of embodiments of the present invention; and

FIG. 14 shows a flow chart representing processes that may be used in accordance with embodiments of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention provide graphical information regarding one or more patients' medical information, and may be used in various methods of graphical comparison, including graphical comparison between patients, over time with a single patient, and/or over time with and/or between multiple patients. Embodiments of the invention may be used in place of and/or in conjunction with existing methods and systems for conveying medical information, including one or more textual methods and systems. The graphical information may be provided electronically to any electronic or computer device or may be provided in hard copy, such as a part of a patient's chart. The use of graphical patient medical information permits rapid and improved conveyance of information, and may improve recognition and understanding of the most relevant medical information, as will be understood below.

Medical information, as used herein, should be interpreted broadly, and includes any information that may be medically relevant, including symptom information, general patient information, medical history information, family medical history information, medicinal information, treatment information, dietary information, pharmaceutical information, or any other information that relates to an individual.

Embodiments of the invention utilize graphical methods and systems to rapidly convey medical information, such as to medical professionals and to laypersons, including to patients. While particular graphical methods and systems are described herein, the illustrated systems and methods are intended to be illustrative. It is anticipated that alternative graphical methods and systems may be utilized other than those specifically described herein, and such alternative embodiments are embraced by the invention and the full scope of the invention should be determined by reference to the appended claims.

In accordance with an embodiment of the present invention, each item of medical information receives a rating, score, grade, mark, evaluation, or other count, such as from one to ten, one to five, one to fifty, zero to ten, etc., and the rating information is stored. The received rating information is received numerically or graphically, or is determined based on one or more responses to queries as to the patient's medical information. The information can also be received electronically, such as utilizing a computer or electronic device, or can be transferred into an electronic format from a paper, dictation, or other format. The received rating information is then displayed graphically, such as using a bar chart, a pie chart, utilizing color information, or by some other graphical format, where it can be quickly and rapidly viewed and digested.

In at least some embodiments, multiple individual pieces of information are displayed graphically, and some individual pieces of information are combined to provide one or more average scores, ratings, etc. The average of multiple scores, ratings, etc. can also be provided or displayed graphically, either as part of a graphical representation of the individual scores, ratings, etc., or individually, or in combination with multiple average scores, ratings, etc. representing averages of other information items. In some embodiments, averages of several averages are displayed, and any number of layers of averages is provided. In some such embodiments, a user elects to drill down (and back up, if desired) through layers of graphical representations of averages, to better understand certain average scores and their components.

The graphical information provides a way to view, understand, and utilize medical information that has heretofore been unavailable. Medical professionals and even laypersons can quickly view and grasp a patient's medical situation using embodiments of the present invention in ways that were previously impossible. The information can be additionally utilized in ways previously unavailable to assist in diagnosis and treatment. While not all advantages and improvements in patient diagnosis, treatment, and care provided by the embodiments of the invention have been explicitly set forth herein, it is anticipated that such advantages and improvements will be understood from the description and Figures and by practicing the invention.

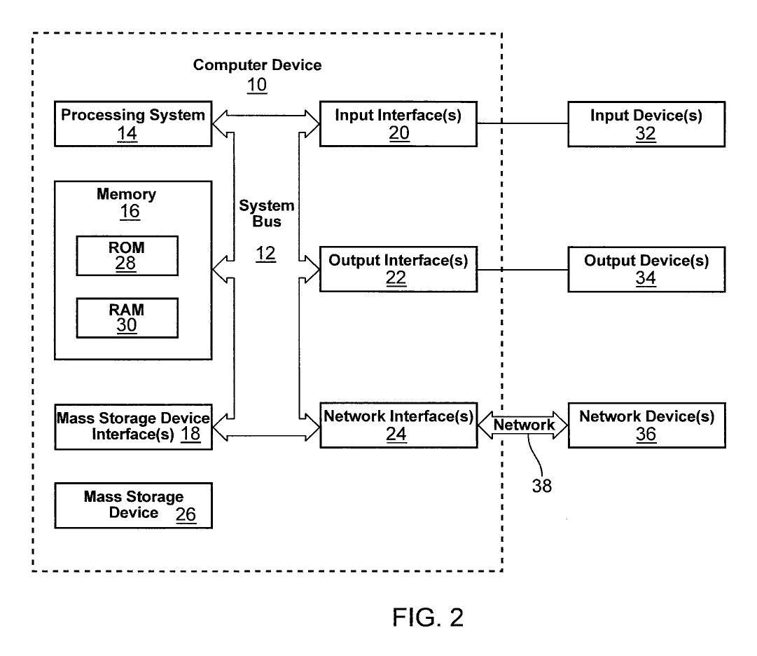

FIG. 2 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 2, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.). In another embodiment, the system configuration includes one or more client computer devices, optionally one or more server computer devices, and a connection or network communication that enables the exchange of communication to an output device, which is configured to perform multi-colorant rendering.

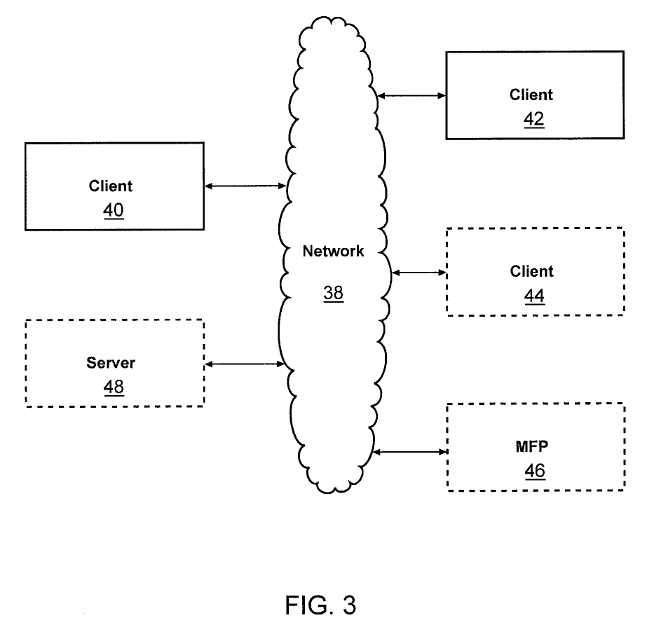

Those skilled in the art will further appreciate that the invention may be practiced in networked computing environments with many types of computer system configurations, FIG. 3 represents an embodiment of the present invention in a networked environment that includes clients connected to a server via a network.

In the representative embodiment illustrated in FIG. 3, one or more clients (40, 42, 44) can access patient information across a network 38, such as from server 48, for the rendering of the information in accordance with embodiments of the present invention on the one or more clients (40, 42, 44) and/or using a printing device, such as MFP 46.

While FIG. 3 illustrates an embodiment that includes a client 40, two additional clients, client 42 and client 44, one peripheral device, MFP 46, and optionally a server 48, which may include a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments. Embodiments in accordance with the present invention further include a multitude of clients throughout the world connected to a network, where the network is a wide area network, such as the Internet.

As embodiments of the invention provide graphical representation of medical information, any type of display device or technology may be used in conjunction with embodiments of the present invention, including televisions, monitors, projectors, general-purpose and custom handheld screens, etc. It will be appreciated that future computer and graphical display technology may also be utilized with embodiments of the present invention.

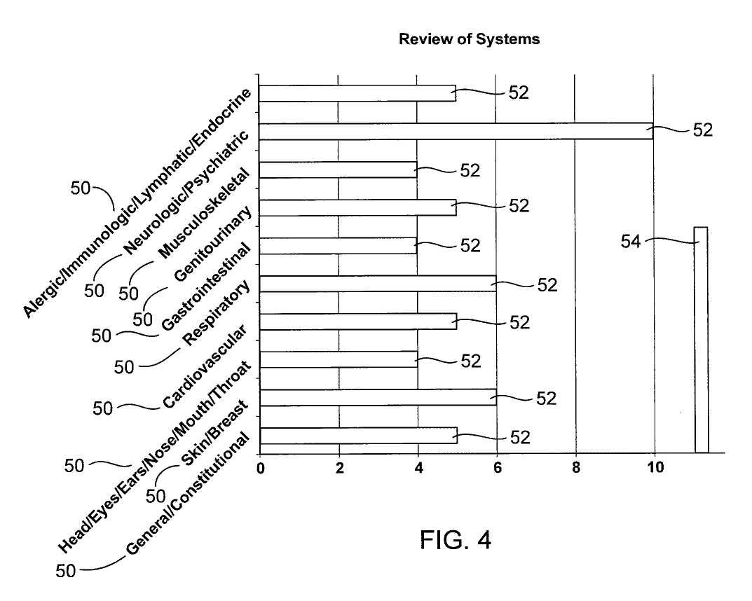

One embodiment of a graphical representation of patient medical information, as it may be generated by a computer, a dedicated electronic device, or by any other process (as will be appreciated below), is illustrated in FIG. 4. As has been discussed above and will be discussed below, the graphical representation of FIG. 4 is merely illustrative. The graphical representation of FIG. 4 provides a general review of systems, and may provide a user (such as a medical professional or a layperson) with a general overview of a patient's past or present medical status. In the illustration of FIG. 4, the graphical representation has been provided with a number of categories 50, each category 50 having a graphical score 52 associated therewith. The categories 50 may include any desired category selections, and may be varied to suit a particular purpose, such as a particular diagnostic design, a particular type of medical practice, etc. The categories 50 of FIG. 4 may be considered to be a general review of systems, and therefore include the following category selections: 1) Allergic/Immunological/Lymphatic/Endocrine, 2) Neurologic/Psychiatric, 3) Musculoskeletal, 4) Genitourinary, 5) Gastrointestinal, 6) Respiratory, 7) Cardiovascular, 8) Head/Eyes/Ears/Nose/Mouth/Throat, 9) Skin/Breast, and 10) General/Constitutional. While ten category selections are represented among categories 50, any number of selections may be included.

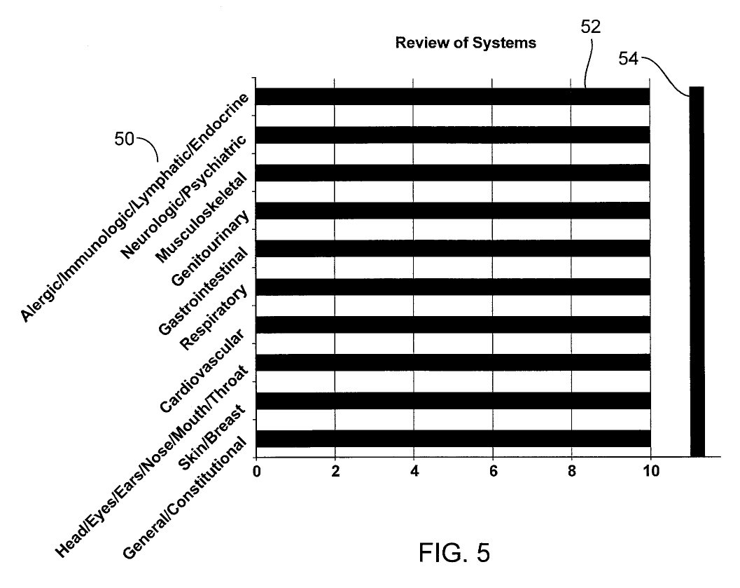

As set forth above, each category has a graphical score 52 associated therewith. In the graphical representation of FIG. 5, the graphical scores 52 may range from zero to ten. This number has been arbitrarily selected, and such scores may range on any desired scale, such as from zero to five, one to ten, one to five, zero to fifty, etc. In addition, the graphical scores 52 need not necessarily have corresponding numerical values, per se, but may have other graphical signals, such as color, shape, or intensity, to represent the graphical scores 52. In the representation of FIG. 4, the numerical value of the graphical scores 52 may have wellness associated with either the maximum or the minimum score value (i.e. either ten or zero in the scale of FIG. 4). That is to say that in some embodiments, a high value of the graphical score 52 may represent wellness in the corresponding category 50, while in other embodiments, a low value of the graphical score 52 may represent wellness in the corresponding category 50. In some embodiments, the user may elect whether the high value or the low value represents maximum wellness, and in some embodiments, the representation may be switched at will.

Thus, in a system where a high value represents wellness, a display such as shown in FIG. 4 would indicate the highest degree of wellness in the system category 50 of “Neurologic/Psychiatric,” as that category 50 has a maximum rightward graphical extent/graphical score 52, corresponding to a numerical score of ten. In contrast, in a system where a low value represents wellness, a display such as shown in FIG. 4 would indicate the highest degree of wellness in the system categories 50 of “Musculoskeletal,” “Gastrointestinal,” and “Head/Eyes/Nose/Mouth/Throat,” as each of those categories 50 have the minimum rightward graphical extent/graphical score 52, corresponding to a numerical score of four.

As may be appreciated, a user viewing a graphical representation such as depicted in FIG. 4 will be very quickly able to determine areas of potential trouble for the associated patient. Indeed, as the user becomes familiar with the information displayed in the graphical representation, it will become less necessary for the user to refer to the category descriptions that may be displayed on the graphical representation, and such descriptions may even be omitted from some displays in at least some embodiments. Indeed, though the numerical values corresponding to the graphical scores 52 are shown along the bottom axis of the graphical representation of FIG. 4, in some embodiments those values may be omitted and the relevant information may be displayed exclusively through the rightward extent of the graphical scores 52.

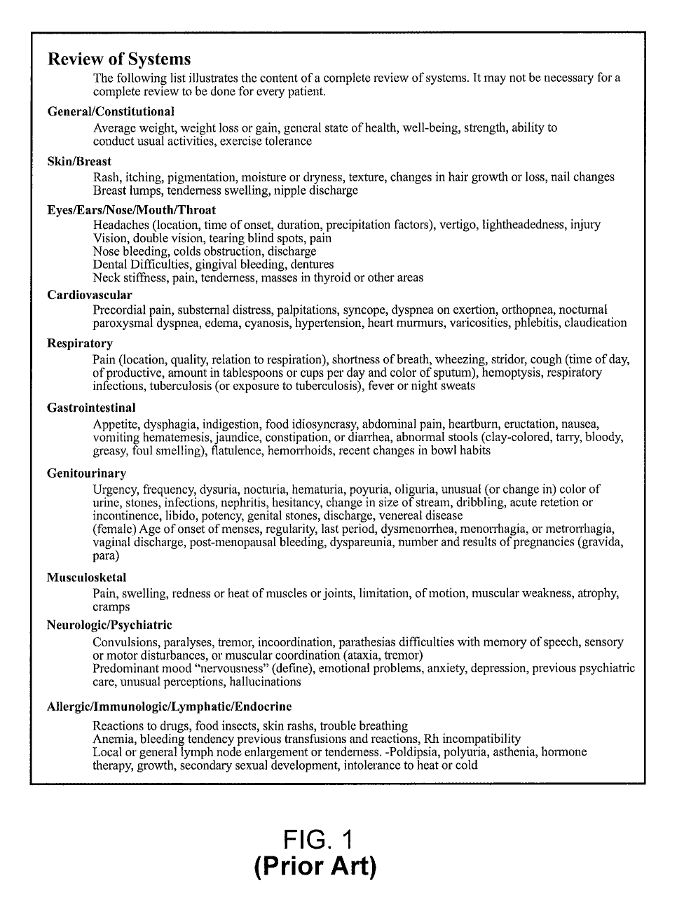

Even when the various categories 50 are labeled, a user of embodiments of the present invention need not fully utilize all the information contained in the various labels. For example, a general physician may review the graphical representation of FIG. 4 and may immediately determine that the most troubling item is the “Neurologic/Psychiatric” category (assuming a low score represents wellness), and may only read the label for that category on a first examination. Thus, instead of having to wade through a long written list of positive and negative symptom information (see the PRIOR ART information of FIG. 1), the physician can obtain what is likely the most relevant and important information at a glance. Other, less important information may also be rapidly conveyed, and may be further investigated as warranted.

In some embodiments, additional graphical information may be provided. For example, the graphical representation of FIG. 4 includes an average graphical score 54. The average graphical score 54 may represent an average of all the graphical scores 52 shown in the graphical representation, or may represent some other average or information. The average graphical score 54 may be represented in a different graphical orientation or format for contrast and/or clarity (as shown in FIG. 4), or it may be represented similarly to the other graphical scores 52 and set apart via textual information or some other identifier. The user may reference the average graphical score 54 to obtain more general information about all the medical information represented, such as the patient's general health.

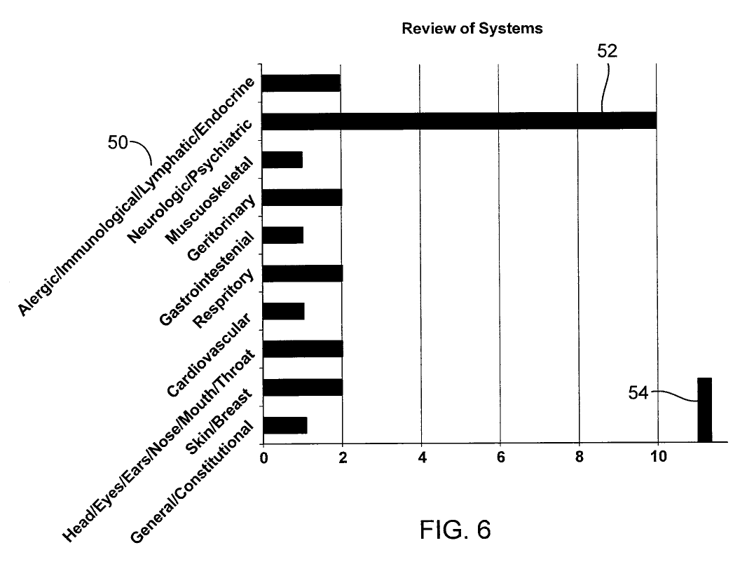

FIGS. 5 and 6 present graphical representations similar to that of FIG. 4. The graphical representation of FIG. 5 may correspond to a hypothetical perfectly-healthy individual, if a high graphical score 52 represents wellness. Alternatively, if a high graphical score represents sickness, the graphical representation of FIG. 5 might correspond to a patient suffering from hypochondria or to a very-ill patient. The graphical representation of FIG. 6 would likely be quickly interpreted as representing a generally-well person with one problematic area or a generally-sick person with one area of no concern, depending on whether high or low graphical scores 52 correspond to wellness. Regardless, it will be readily apparent from FIG. 6 that a user of the embodiments of the present invention will be able to nearly instantly determine problem and/or non-problem areas utilizing the graphical representations discussed herein in a way not currently available.

It should be appreciated that in some instances it may be desirable to provide more detailed information than can be graphically represented in a single graphical representation (such as those of FIGS. 4-6). In some embodiments, additional information may be presented textually or otherwise. Alternatively or additionally, in some embodiments, additional information may be presented graphically. For example, a user may decide that he or she wants more information about a specific category 50, such as “Musculoskeletal.” In some embodiments, a user may either turn to a page representing additional information related to the selected category 50 (if the graphical representations are in hard copy format), or may utilize an input device to select a particular category 50 or graphical score 52 for more information. In this way, the user can “drill down” to find more information.

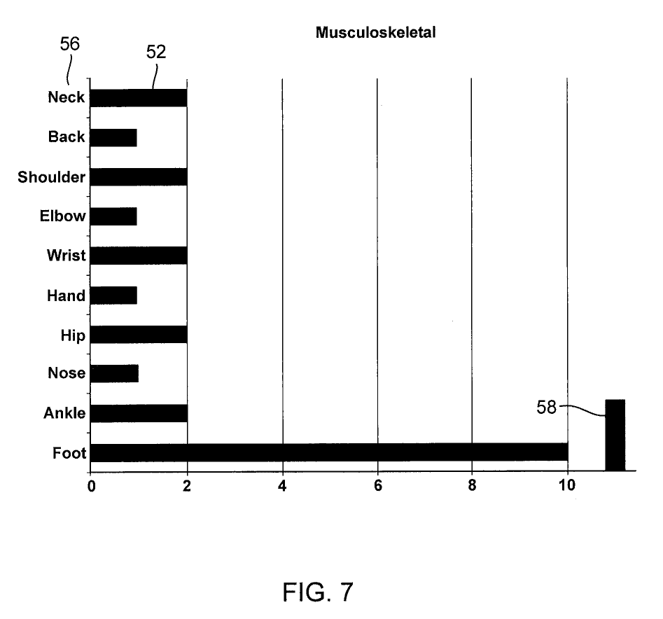

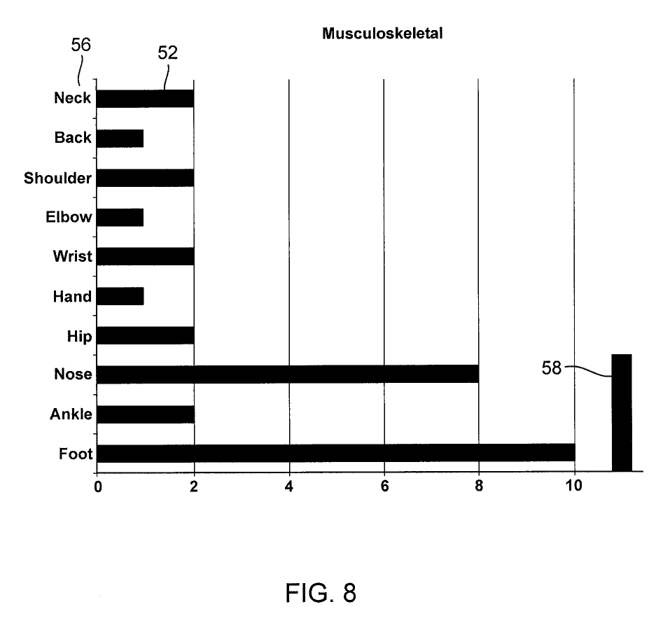

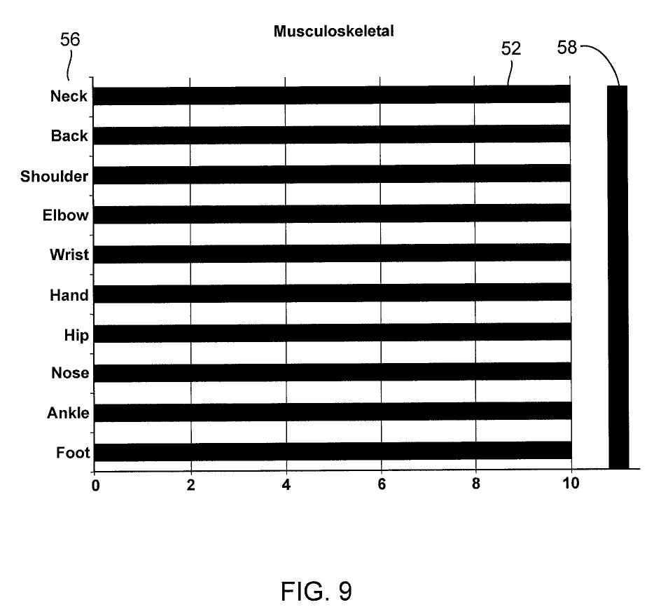

FIGS. 7-9 show representations of a graphical representation that might be displayed upon selection of the “Musculoskeletal” category 50. In these Figures, the categories 50 might be replaced by new subcategories 56. The subcategories 56 may represent the information utilized to provide the graphical score 52 associated with the general “Musculoskeletal” category 50 (as shown in FIGS. 4-6). Additionally, a subcategory average graphical score 58 may be provided, and the subcategory average graphical score 58 may be the same as the graphical score 52 shown in conjunction with the general “Musculoskeletal” category 50 (as shown in FIGS. 4-6). By way of example only, the subcategories 56 such as shown in FIGS. 7-9 may include 1) Neck, 2) Back, 3) Shoulder, 4) Elbow, 5) Wrist, 6) Hand, 7) Hip, 8) Knee, 9) Ankle, 10) Foot. While ten subcategories 56 have been illustrated, any number of subcategories 56 may be utilized, such as to suit a particular diagnosis or treatment purpose.

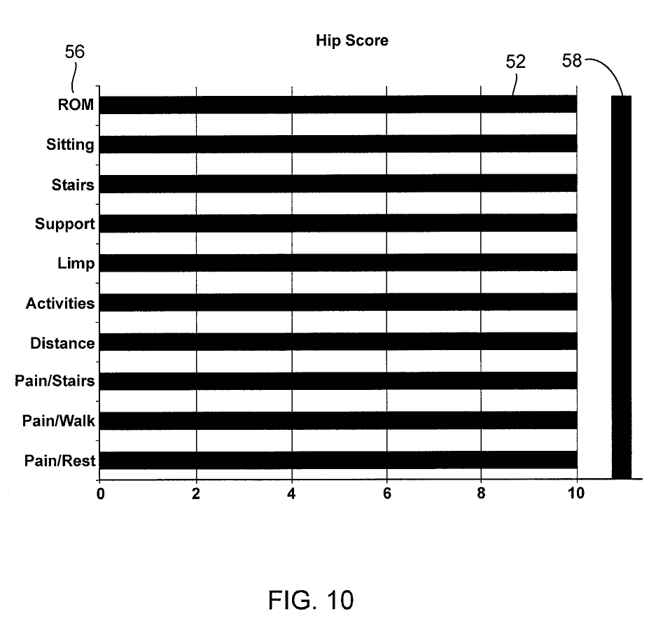

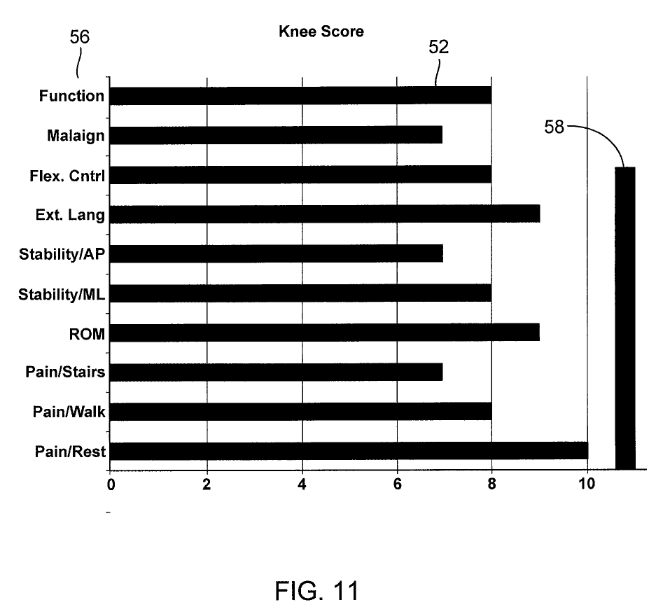

The subcategories 56 and the graphical scores 52 associated therewith may be utilized in similar fashion to the categories 56 and the graphical scores 52 associated therewith. In addition, further drilling down to more specific medical information (whether textually-displayed, graphically-displayed, or otherwise-displayed) may be possible. For example, if one of the “Hip” or “Knee” subcategories 56 or corresponding graphical scores 52 of FIGS. 7-9 is selected, a new graphical display such as illustrated in FIGS. 10 or 11 may be displayed.

In the graphical display of FIG. 10, new subcategories 56 are presented in relation to the previous subcategory of “Hip,” with their corresponding graphical scores 52 and the corresponding subcategory average graphical score 58. By way of example only, the new subcategories 56 presented may include 1) ROM, 2) Sitting, 3) Stairs, 4) Support, 5) Limp, 6) Activities, 7) Distance, 8) Pain/Stairs, 9) Pain/Walk, and 10) Pain/Rest. In the graphical representation of FIG. 11, new subcategories 56 are presented in relation to the previous subcategory of “Knee,” with their corresponding graphical scores 52 and the corresponding subcategory average graphical score 58. By way of example, the subcategories 56 may include 1) Function, 2) Malalign, 3) Flex. Cntrt., 4) Ext. Lag, 5) Stability/AP, 6) Stability ML, 7) ROM, 8) Pain/Stairs, 9) Pain/Walk, 10) Pain/Rest.

As may be appreciated, further drilling down may be possible, and it may also be possible to drill back up, such as by selecting the subcategory average graphical score 58, the graphical representation title, or a “Back” icon (not shown). Any known mechanism for navigation or moving between graphical displays and representations is embraced by the embodiments of the present invention. In some embodiments, it may be desirable to transition to specific textual comments relating to a particular category 50 and/or subcategory 56 and the associated graphical scores 52. In some embodiments, the transition may occur automatically upon drilling down past a most-detailed level of graphical representation. In alternate embodiments, the transition may occur at any graphical display upon selection by the user, such as by an alternative input at an input device or upon some other selection. In still other embodiments, a link to such textual information (not shown) may be provided with respect to any piece of information/category 50/subcategory 56/graphical score 52/etc.

In some embodiments, the textual information so provided may be provided with detail corresponding to the level of detail in the associated graphical representation. In other embodiments, the textual information may have a single level of detail, and transitioning to the textual information may occur to a particular relevant point within the textual information or may include highlighting the relevant textual information in some way. In some embodiments, the graphical and textual information may be simultaneously presented, such as side-by-side or above-and-below, to best convey information in the manner desired by the user. Additionally, the “textual information” displayed may include graphical or other information of the type currently provided with patient medical information, where appropriate. In this way, the user may be provided with all information available previously, but supplemented with the rapidly-digested graphical information discussed herein.

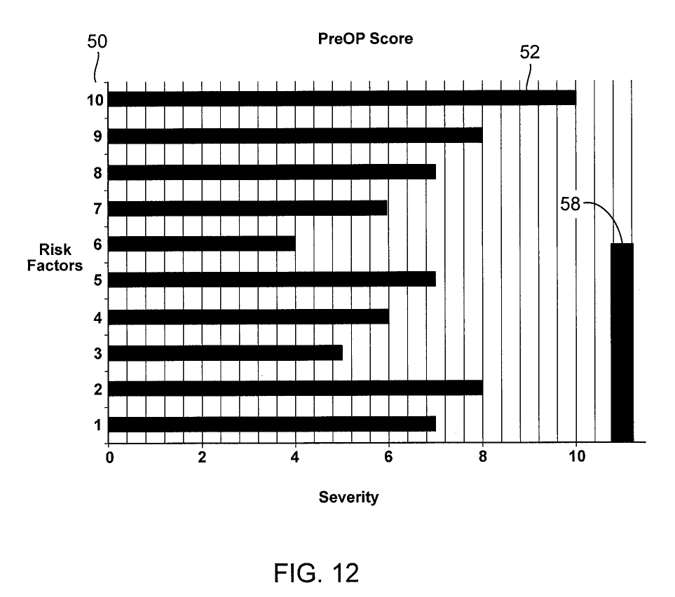

As discussed above, the graphical representations may be customized and/or focused for any specific needed application. For example, FIG. 12 illustrates a graphical representation that might be used to evaluate a patient prior to an operation or other surgical or non-surgical procedure. A medical professional may, at a glance, decide that proceeding under certain circumstances would be unwise and may recommend treatment to lower certain risk factors, etc. Additionally or alternatively, a pre-operation and a post-operation set of graphical representation(s) may be prepared and compared. In this way, an evaluation of the success of the procedure and/or how well the patient came through the procedure may easily be made. This may be done, for example, by preparing and comparing two graphical representations. Alternatively, the pre- and post-information may be prepared on a single graphical representation, and may be demarcated by order, color, shading, placement, identifiers, intensity, etc.

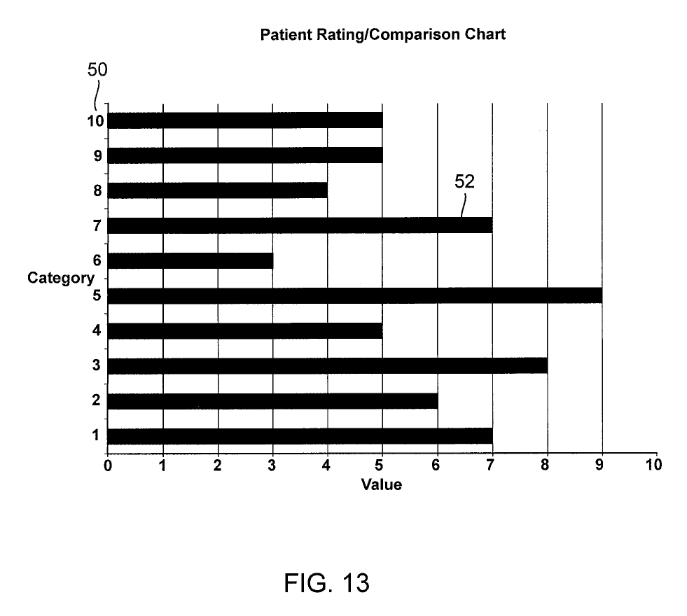

In some instances, graphical comparisons may be made between patients, as is illustrated by FIG. 13. The categories 50 of FIG. 13 may represent individual patients, and may permit rapid comparison between groups. The above-described graphical comparisons between patients and groups is meant to be merely illustrative of the various ways in which the graphical representations of the present invention may provide improved information to users, including medical professionals and laypersons.

For example, a medical professional may begin to recognize and associate certain graphical patterns with certain diagnoses. As an example, a medical professional may recognize that a certain pattern or set of graphical scores 52 in a certain score range is associated with arthritic damage. Upon later encountering a similar pattern or set of graphical scores 52, the medical professional may suspect arthritis. Furthermore, the medical professional might notice a similar pattern emerging for a certain patient, but with scores still more toward healthful than would indicate arthritic damage. The medical professional might suspect early-stage arthritis and might be able to preventatively treat the condition and/or do further testing to confirm the tentative diagnosis. In this way, embodiments of the invention might assist with diagnosis, even in earlier stages than might otherwise be caught, and with treatment.

In some embodiments it may be possible to include software-based or other semi-automatic or automatic recognition of certain graphical patterns to provide tentative or potential diagnosis information to a user. In embodiments where computer programs are utilized, the computer programs may include diagnosis information based on patterns discovered over tens, hundreds, or thousands of patients, along with the associated diagnoses. This information may be displayed with the graphical representations and/or separately.

The above descriptions of possible uses and applications of the graphical patient medical information are considered illustrative only. Additional uses and applications may be learned by the practice of the embodiments of the invention. Additionally, the illustrated graphical representations are intended to be representational only.

For example, while the illustrated graphical representations include bar charts, thereby providing linear graphical scores 52, the graphical scores 52 may be represented in any number of ways. For example, the graphical scores 52 may be represented as colors on a continuum of color. As one example, a red-green or other bi-color graphical continuum may be utilized, with one of the colors (e.g. red or green) representing a more healthful graphical score 52. The graphical scores 52 in such an embodiment may be interpreted by determining how much of one color a graphical score 52 is, or if the graphical score 52 is more in-between (e.g. brown, in the red-green scheme). It will be appreciated that such a representation of graphical scores 52 may permit more medical information to be displayed on a single graphical display, as the graphical scores 52 in such embodiments do not rely on physical size to convey the graphical scores 52.

Other non-limiting alternatives for the graphical scores 52 include shapes (such as square, triangle, circle, hexagon, etc.) for different graphical scores 52, varying shadings for different graphical scores 52, etc. As another example, black or red partially- or wholly-filled bubbles, such as are used by Consumer Reports Magazine might be used in some embodiments. An amount that a pie-chart type graph is filled-might also be used to represent a graphical score 52. In sum, any graphical mechanism or method may be utilized to convey patient medical information by way of a graphical score 52. Some such systems and methods may permit more information to be displayed at a single time, while other methods and systems may be more clear when utilizing certain display media or devices, and one of skill in the art may determine a desired graphical system/method to suit a particular use.

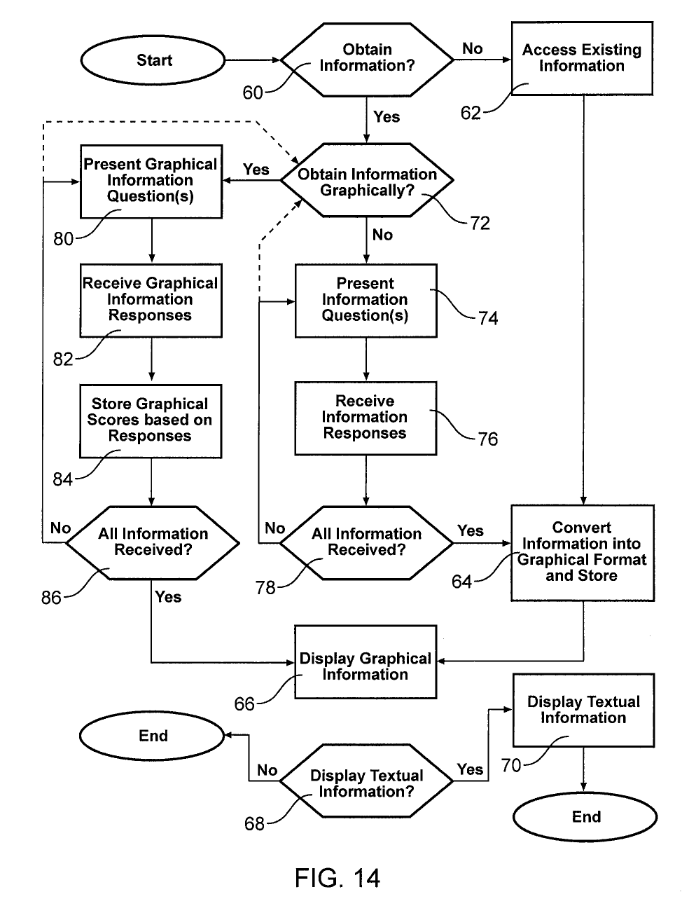

To display the graphical patient medical information, the medical information may be obtained, generated, and/or converted into a graphical format. FIG. 14 therefore illustrates various illustrative methods for obtaining, generating, and/or converting medical information into a graphical format (i.e. into the graphical scores 52). FIG. 14 is a flowchart showing processes that may occur with embodiments of the invention. Execution begins at decision block 60, where a determination is made whether to obtain patient medical information. It may be that medical information has already been obtained. For example, previously-existing information may be utilized.

If no information need be obtained at the present time, execution proceeds to accessing existing information at step 62. Once the information has been accessed, the information may be converted into a graphical format and stored in the graphical format at step 64, then displayed (either immediately or at a later time) at step 66. As set forth previously, it may be desirable to display textual-based medical information, or information in some other previously-available format, and so execution may proceed to decision block 68, where it is determined whether to display such information. This determination may be made by user input, for example. If such information is not to be displayed, execution may end (or return to some earlier point in the process), while if such information is to be displayed, it is displayed at step 70. After the textual information or other information in a preexisting format has been displayed, execution may terminate or return to some earlier point in the process.

The foregoing represents processes that may occur when utilizing preexisting information either entirely or in part. If, however, it is determined at decision block 60 that medical information is to be obtained, execution proceeds to decision block 72. At decision block 72, a determination is made whether to obtain information graphically or otherwise. If it is determined not to obtain information graphically, execution proceeds to step 74, where one or more questions may be presented to draw out the medical information. For example, such questions may be presented by a medical professional during a patient interview, may be presented to a medical professional after observing a patient, may be presented in the form of a medical questionnaire to the patient during a patient intake procedure or otherwise, or may be otherwise presented directly to a patient, such as online. The questions presented need not all be in the form of questions, per se, but may be in any format designed to obtain medical information, and thus any method, system, or mechanism intended to draw out medical information may be utilized at step 74. Execution may then proceed to step 76 where the medical information is received.

Execution then proceeds to decision block 78, where a determination is made as to whether all medical information has been received. If not, execution may return to step 74 where additional information question(s) may be presented, or may return to decision block 72 to determine whether any additional information should be obtained graphically or not. When all non-graphical medical information has been received, execution then proceeds to step 64 for any desired conversion of the non-graphical medical information into a graphical format, whereupon the process may continue as outlined above. Although the process has been illustrated as obtaining all information prior to conversion into a graphical format, it should be understood that conversion may occur in steps while the information is obtained, or may occur simultaneously with receipt.

While information may be obtained in non-graphical ways similar to current methods and then converted into a graphical format, the information may also be obtained graphically. Thus, if it is determined at decision block 72 to obtain information graphically, execution may proceed to step 80, where questions designed to obtain information graphically are presented. As set forth above, the graphical information questions need not necessarily be questions per se, but may include any format designed to obtain medical information. Additionally, the graphical information questions may be presented by medical professionals to patients, may be presented to medical professionals after observing a patient, may be obtained as part of test results, may be presented directly to a patient, such as part of a medical intake process or online, or may be presented and/or obtained in any other fashion.

The graphical information questions are designed to receive responses either in a graphical format or in a format easily and automatically converted to a graphical format. A format easily converted into a graphical format includes formats such as letter and number grades/scores within a known range or scale. Graphical responses may be received by any graphical selection method, system, or format, including graphical sliders, receipt of a graphical click or other selection on a graphically-displayed range by way of a mouse or other input device, selection of a radio button or option button, receipt of a color or intensity selection, or receipt of any other graphical signal or cue or representation thereof. However the graphical information is received, it is stored at step 84, and then a determination is made at decision block 86 whether all information has been received. If not all information has been received, execution returns to step 80 for more presentation of graphical information questions, or to decision block 72 for a determination whether the additional information is to be obtained graphically or otherwise. Once all information has been obtained, execution may proceed to step 66 for displaying of the information. As will be understood, no conversion of the graphically-received information to a graphical format need occur.

It should also be understood that receipt of graphical information and receipt of information otherwise are not exclusive of each other, and information may be received both graphically and otherwise together, whether serially or simultaneously, and may be stored both graphically and/or otherwise, together or separately. It should also be understood that information may be received, converted, obtained, etc. into a graphical format by any other method or process.

While the methods and processes of the present invention have proven to be particularly useful in the area of medical care, those skilled in the art can appreciate that the methods and processes can be used in a variety of different applications, including in the area of providing dietary decisions, fitness evaluation, and other types of care, diagnosis and treatments to an individual.

In some embodiments, a medical information graph that provides a review of systems of an individual's body (e.g., FIGS. 4-6) can be drilled up to a level that is even broader than the particular systems of the individual's body. Examples of a broader graphical view of the individual includes information relating to the individual's medical status, dietary status, financial status, education, genetic information, family traits, family conditions, other background information, and/or other data or information that relates to the individual. Thus, the medical information graph can be drilled up to levels that provide broader categorical information relating to the individual, wherein each level drilled up is increasingly broader. Similarly, each graph allows for drilling down or into subcategories to provide more information relating to the particular subcategory, wherein each level drilled down is increasingly more focused, narrow or specific.

Accordingly, embodiments of the present invention relate to graphically representing aspects of an individual for rapidly conveying information about that individual, wherein the information can be anywhere from a macro level of the individual to a micro level of the individual, and wherein the various levels can be drilled up to convey broader information and drilled down to convey more focused, narrow or specific information.

Thus, as discussed herein, embodiments of the present invention relate to patient evaluation systems and methods, and more particularly to graphical methods and systems for rapidly conveying medical information.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A system for graphically conveying medical information, the system comprising:
a plurality of categories of medical information;
a plurality of graphical scores associated with the categories of medical information; and
a display mechanism for communicating the graphical scores in a graphically succinct manner.

2. The system of claim 1, wherein the graphical scores and the categories are displayed on the display mechanism.

3. The system of claim 1, wherein each of the plurality of categories further comprises a plurality of subcategories of medical information, each subcategory further comprising a plurality of graphical scores associated with the subcategories of medical information.

4. The system of claim 3, further comprising means for selecting at least one of the plurality of categories and the plurality of subcategories.

5. The system of claim 1, wherein the graphical score is represented by at least one of:
(i) a color;
(ii) a shape;
(iii) a shading;
(iv) an intensity;
(v) a design;
(vi) a graph; and
(vii) a pattern.

6. A computer program product for implementing within a computer system a method for graphically accessing and rendering patient medical information, the computer program product comprising:
a computer readable medium for providing computer program code means utilized to implement the method, wherein the computer program code means is comprised of executable code for implementing steps for:
rendering a plurality of categories of medical information; and
graphically rendering a plurality of scores associated with the categories of medical information for communicating the scores in a graphically succinct manner.

7. A computer program product as recited in claim 6, wherein the computer program code means further comprises executable code for implementing a step for associating at least some of the categories of medical information into a layered hierarchical relationship.

8. A computer program product as recited in claim 7, wherein the layered hierarchical relationship comprises layers of average scores.

9. A computer program product as recited in claim 8, wherein the step for graphically rendering a plurality of scores comprises:
obtaining an average of at least some of the plurality of scores; and
graphically rendering the average.

10. A computer program product as recited in claim 7, wherein the computer program code means further comprises executable code for implementing a step for allowing a user to drill from one layer to another layer in order to access medical information.

11. A graphical communication method for succinctly and effectively communicating patient medical information, the method comprising:
identifying a first category of medical information;
rendering a graphical score for the first category of medical information;
identifying a second category of medical information; and
rendering a graphical score for the second category of medical information.

12. The method of claim 11, wherein the graphical score for the first category of medical information and the graphical score for the second category of medical information each represent a first point in time for the first category and the second category, respectfully, the method further comprising:
providing a second graphical score for the first category and a second graphical score for the second category, the second graphical score for the first category and the second graphical score for the second category each representing a second point in time for the first category and the second category, respectfully; and
rendering the first and second graphical scores for the first and second categories to assist in graphical diagnoses and evaluation, wherein the graphical scores are displayed in one of:
a simultaneous display; and
a serial display.

13. The method of claim 12, wherein at least one of the first category and the second category further include a plurality of subcategories.

14. The method of claim 11, wherein each graphical score represents at least one of a condition, a symptom, a diagnosis, a wellness, an illness, a strength, a weakness, a content, a percentage, a concentration, an ailment, a rigidity, a flexibility, a level of pain or discomfort, an average, an improvement, and a capacity of a patient.

15. The method of claim 11, wherein said rendering the graphical scores comprises at least one of providing a a color, a shape, a shading, an intensity, a design, a graph, and a pattern to represent the graphical scores.

16. The method of claim 11, further comprising providing an average graphical score for the graphical score for the first category and the graphical score for the second category.

17. The method of claim 12, further comprising providing a first average graphical score for the first point in time and a second average graphical score for the second point in time.

18. The method of claim 12, further comprising:
providing an average graphical score for the graphical scores of the first category; and
providing an average graphical score for the graphical scores of the second category.

19. The method of claim 11, wherein the first category comprises a plurality of categories of medical information, each of the plurality of categories of medical information further having an assigned graphical score, wherein the plurality of assigned graphical scores is displayed to the user to rapidly and graphically convey medical information to the user.
